(19) United States
(12) Patent Application Publication
(10) Pub. No.: US 2006/0282776 A1
(43) Pub. Date: Dec. 14, 2006

(54) MULTIMEDIA AND PERFORMANCE ANALYSIS TOOL

(76) Inventors: Larry C. Farmer, Orem, UT (US); Gerald R. Williams, Provo, UT (US); Greggory R. DeVore II, Valencia, CA (US); Trevor K. DeVore, La Canada, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/423,417

(22) Filed: Jun. 9, 2006

Related U.S. Application Data
(60) Provisional application No. 60/689,695, filed on Jun. 10, 2005.

(51) Int. Cl. G11B 27/00

(52) U.S. Cl. 715/719; 715/723; 715/769; 715/764

(57) ABSTRACT

Events and tags are assigned to recorded multimedia content through the use of different tools and interfaces to segment the content as well as to provide commentary corresponding to the content and/or to reference other content. One interface includes a timeline corresponding to the multimedia content, which is displayed with a selected combination of tags and events. The tags and events are visually distinguishable within the timeline from other tags and events by their respective colors and graphical representations. Events and tags can be filtered and sorted according to various parameters and characteristics. Some events and tags can also be shared for use on different computing systems with the same or different multimedia content.

### CROSS-REFERENCE TO RELATED APPLICATIONS

This application claims the benefit and priority of U.S. Provisional Application No. 60/689,695, filed Jun. 10, 2005, which is incorporated herein by reference in its entirety.

### BACKGROUND

1. Field of the Invention

The present invention generally relates to methods, systems and computer program products for evaluating recorded performances as well as other recorded multimedia content and for annotating the multimedia content.

2. Background and Relevant Art

Technology has vastly improved the ability to measure and evaluate performances of dancers, musicians, athletes, actors, orators and virtually every other type of performer. For example, the audio/visual aspects of a performance can now be recorded on a tape or other fixed media for subsequent playback and detailed review.

Although the ability to record a performance has been possible for quite sometime, recordings were typically only made on tape, until recently, which limited their convenience and functionality. The limitations of tape recordings, for example, are particularly noticeable in comparison to the flexibility and convenience of recordings made in an electronic format.

One of the conveniences associated with recordings in electronic format is the flexibility in controlling the playback of the electronic recording. For example, a user can easily and immediately advance to a desired segment within a recording on a disk or a computer by skipping past undesired content with the simple push of a button or by dragging a scrubber. Content that is recorded on a tape, on the other hand, can only be advanced by fast-forwarding or rewinding and cannot be instantaneously skipped.

While advances in the audio/video recording industry have drastically improved the convenience of recording and playing back a multimedia recording, the ability to advance to a specific spot within the recording can still be somewhat difficult to control when the recording is not properly segmented and indexed. Initially, it can be difficult for a user to specify which content to advance to within a recording when the recording has not been indexed. Furthermore, even if the user is able to specify or define a particular type of content to advance to, the multimedia player may not be able to successfully respond if the content is not associated with an electronic identifier of some sort.

Accordingly, the convenience of immediately advancing to a desired portion of a recording is limited by the proximity of electronic identifiers to the desired content, such as, for example, the beginning or ending of a defined segment. After a user identifies a defined segment, the user must then move to the specified location on the tape or in the digital content.

To minimize the amount of input required from a user, many multimedia recordings are segmented by intervals of time, such that a user can jump to almost any segment or content based on a relative time reference within the recording. However, such navigation is only beneficial if the user knows what the relative time of the desired content is within the recording. Even then, the desired content may be buried within that segment.

To help overcome for some of the foregoing limitations, various software applications have been developed to provide user control over the identification and indexing of content within a recording. When desired content is identified by a user, for example, recording and editing software assigns electronic identifiers or markers to the selected content, which can later be identified by an electronic reader, and so that the user may immediately proceed (advance or more back) to the corresponding content. In some instances, the segment marker is a particular frame within the recording. In other instances, the marker is new data added to the recording.

Titles, headings, comments, and other annotations associated with each segment can also be created and assigned to the content for later review. This is particularly beneficial when a performance is annotated with comments and a performer later reviews the performance along with feedback associated with their performance. Metadata and other identifiers are used to associate and reference annotations with the multimedia performance so that it can be rendered simultaneously. An index can also be generated and presented to the user to display the various segments within the recording. Thereafter, whenever a segment is selected, the multimedia player can immediately proceed (advance to or move back to) to the selected segment and display the corresponding multimedia and annotations.

The manner in which a recording is segmented can vary to accommodate different needs and preferences. As mentioned above, segments are sometimes limited by predetermined intervals of time. In other instances, segments are limited by their corresponding content or subject matter. For example, in a theatrical play, a new segment might be created for each scene or act. Similarly, the transitions and breaks between chapters in a book or movie can be used to define and separate segments.

While there are many different ways to define segments, as suggested above, existing software interfaces appear to be somewhat limited in their ability to visually distinguish and filter different types of segments, absent the display of text provided in an index.

Existing multimedia tools are also somewhat limited in their ability to identify and filter segments based on commentary generated by different authors or that correspond to different content. In fact, absent the use of linguistic titles in an index, there does not appear to be any readily available means within existing software for identifying the presence and location of segments and associated annotations within a recorded multimedia file or for filtering their display.

Yet another problem with existing annotating and performance analysis tools is the difficulty in categorizing and visually distinguishing between the different types of events and comments associated with the performance or multimedia content and for generating filtered views of the commentary and annotations.

Accordingly, notwithstanding the noticeable advances in the audio/visual recording industries, there is still a need for improved tools for evaluating and annotating multimedia content.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

This application describes various methods, systems and computer program products for enabling a reviewer to categorize and annotate multimedia content, including recorded performances, and to segment the multimedia content with events and tags. The events and tags are used to identify, define and comment on the multimedia content, as well as to reference and link to other data.

An event may or may not, by itself, communicate descriptive information about the content corresponding to the event. For example, in some embodiments, an event defines a particular incident or occurrence. In other embodiments, an event merely corresponds to a defined duration or quantity of a multimedia recording.

Tags are used to provide different types of information. Sometimes tags define the content within a segment or event. Tags can also provide commentary and feedback, or pose questions. Tags can also reference and link to multimedia content and other resources.

Some events and tags are created by the end user, other tags and events are generated by a third party and utilized by the user or other third parties. The events and tags can be stored and utilized at a single computing system or shared and utilized in a collaborative or other distributed environment.

Annotations, comments, display characteristics and/or other multimedia assigned to each event and tag can be modified at any the time.

The events, the comments and tags corresponding to the segmented events and their corresponding displays can be filtered, sorted and/or searched according to various parameters, including, but not limited to the creator of the tags/events, by category, by term and by event type, as well as any other definable attribute or characteristic of the events and tags.

In some embodiments, an event is created when a tag, corresponding to a category, description, or an annotation, is selected and dropped onto a visual display of the multimedia content. The visual display can include an actual reproduction of the recorded multimedia content as well as a representative timeline corresponding to the multimedia content.

When an event is created, it is assigned a start time and, if desired, an end time corresponding to the respective presentation time of the content within the multimedia recording. One or more tags, each having one or more corresponding annotations or comments are also assigned to each event. In some embodiments, events can also be created independently of tags, and such that they represent stand-alone annotations with corresponding comments or significance. Tags can also be added to events at any time, including stand-alone events that were previously created.

In some instances, the timeline is displayed with a selection of referenced annotations, including any combination of tags and events. The combination of tags and events that are visually displayed with the timeline are selected, filtered, and/or modified according to various parameters, such as, but not limited to the entity that created the tags and/or events, by categorization of the events and/or tags, by tag type or by event type. The displayed combination of referenced annotations can also be selected and filtered so as to display only tags, while omitting the display of events, or to display only events, while omitting the display of tags.

Distinctions between the displayed tags and events are visually perceptible through the use of coloring and display schemes correspondingly assigned to the different types of tags and events based on their various characteristics (e.g., author, category, annotations, and so forth). By using different colors and graphics to distinguish between the different tags and events, a user is able to visually distinguish and filter the tags or events associated with a particular entity, content or other tag/event attribute, even when a plurality of different tags and/or events are displayed at the same time and without requiring a screenshot or text description for each referenced annotation within the timeline.

In some instances, a reviewing pane is provided to view and sort a textual description of the events and tags or only a selected set of events or tags corresponding to a particular entity, event, or categorization. Although the reviewing pane provides a more detailed and textual description of the tags and events, various color schemes, fonts, and graphic selections can also be used to further aid the user in identifying and distinguishing between the tags, events, annotations, etc.

When an event or tag includes annotations or comments from multiple entities, the fonts and colors of the textual comments can also be altered to distinguish between the authors of the comments within a single tag or event commentary.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more filly apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates one embodiment of an interface for presenting and annotating multimedia content with events and tags;

FIG. 2 illustrates another embodiment of the interface shown in FIG. 1 and in which a list of tags is presented for selection;

FIG. 3 illustrates a flowchart of one embodiment for annotating multimedia content and that includes generating, displaying and editing events;

FIG. 4 illustrates a flowchart of one embodiment for modifying a timeline.

### DETAILED DESCRIPTION

The present invention extends to methods, systems and computer program products for recording, rendering and annotating multimedia content with events, tags and comments that correspond to the multimedia content and other data.

Tags and events assigned to multimedia through the methods and systems of the invention enable a user to provide commentary and feedback regarding performances and other multimedia presentations. Tags and events can also be used to reference other resources and data.

In some embodiments, a timeline is displayed with a combination of tags and events that identify the presence and location of annotations within a multimedia file. The tags and events are visually distinguishable within the timeline by color or graphical representation. The combination of tags and events that are displayed on the timeline, or in another frame, are selectably filtered and/or sorted according to virtually and characteristic or attribute of the tags and events.

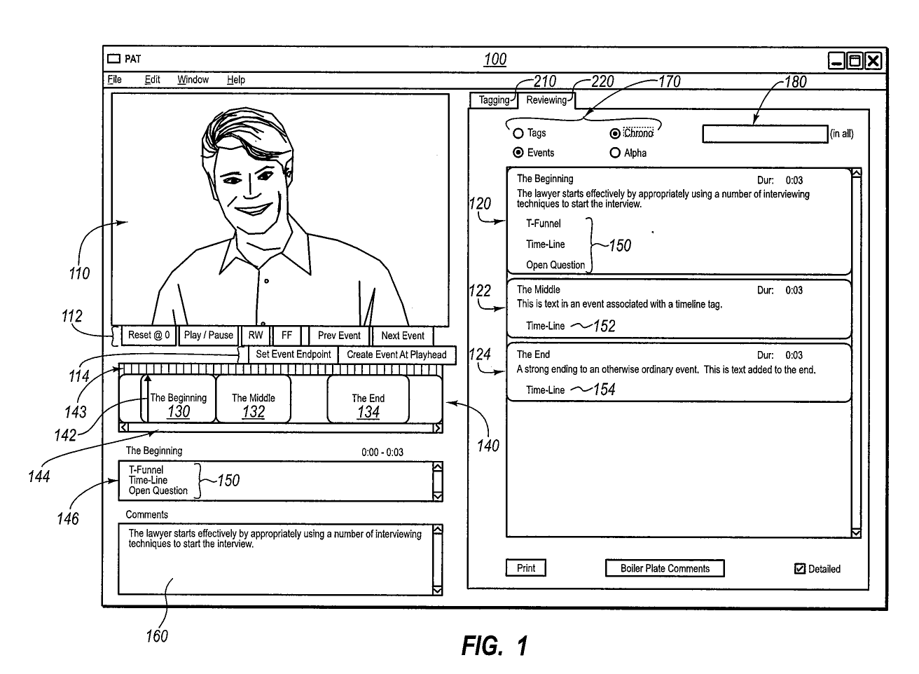

Descriptions of certain embodiments of the invention will now be provided with reference to the interfaces and flowcharts illustrated in FIGS. 1-4.

FIG. 1 illustrates one embodiment of a computerized interface 100 for presenting and annotating multimedia content. One component of the illustrated interface 100 is a display frame 110 for displaying multimedia content. Although the display frame is currently shown as rendering an image corresponding to a video file, it will be appreciated that the display frame 110 is also capable of rendering graphical representations of audio, such as, for example, by using waveform and amplitude displays, and other graphical displays. Accordingly, although many of the examples provided herein refer to multimedia within the context of video, it will be appreciated that the methods and systems of the invention also extend to embodiments in which the multimedia comprises animations, video, still images, audio and combinations thereof.

In some embodiments, interface objects 112 for controlling the presentation of the multimedia content are also provided. For example, a user can alternatively select the interface objects to initiate the execution of computer-executable instructions for playing, pausing, fast-forwarding, rewinding, skipping, and for controlling the presentation of the multimedia content in any other desired manner. Although only a limited set of interface control objects 112 are currently shown, it will be appreciated that virtually any type of control object and corresponding computerized instructions can be provided for controlling the presentation of the multimedia in a desired way.

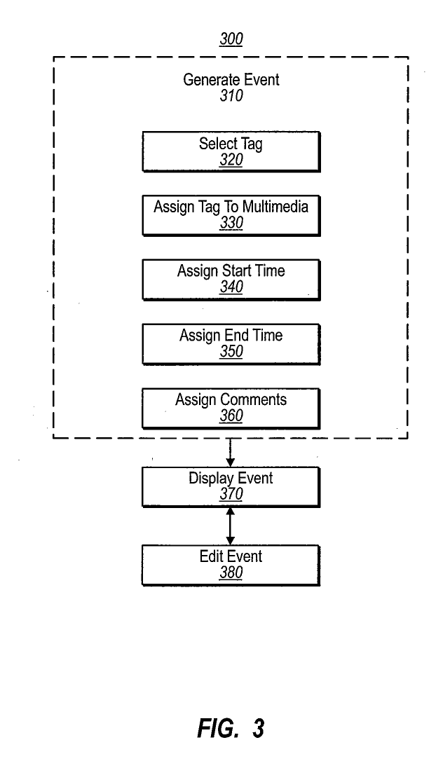

Control objects 114 for initiating the creation of an event are also shown. These control objects 114 can be selected by a user to initiate the creation of an event corresponding to a particular portion of the multimedia being rendered. The portion of the multimedia that the event will be assigned to is defined by relative start times and end times. As described below, the start and end times can be set manually or automatically. The creation of events and tags will be described in more detail below with specific reference to FIG. 3.

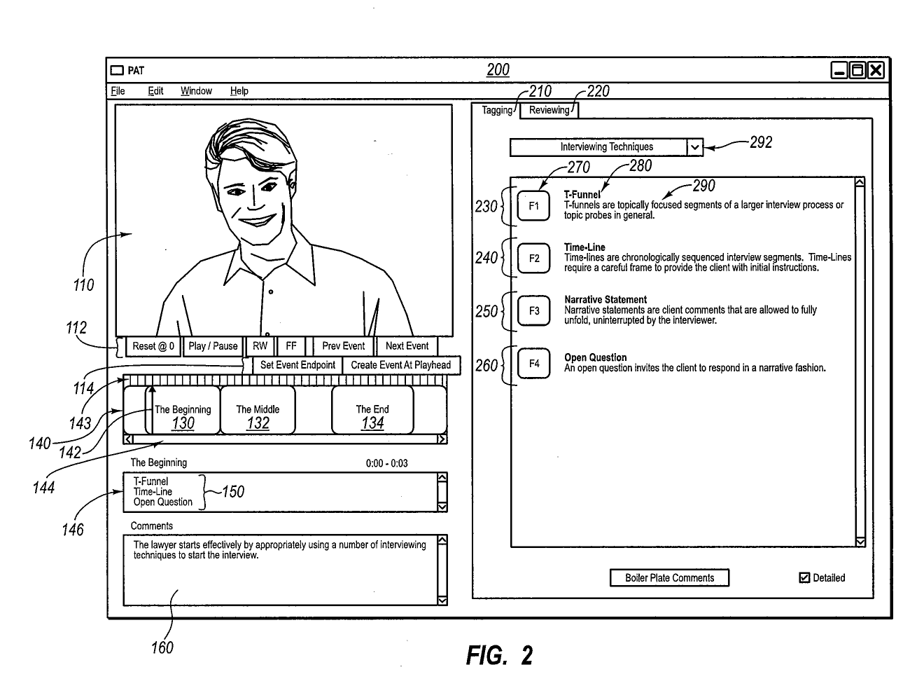

As shown in FIGS. 1 and 2, a timeline 140 is also presented for graphically representing the duration and relative playback position of the multimedia, as it is being rendered. Although not necessary, the timeline can include an indicator 142 to specifically identify the relative and temporal playback position of the multimedia as it is being rendered. Time or position markers 143 can also be provided. In some instances, the position markers can be selected to advance the playback of the multimedia to the relative presentation time corresponding to the selected marker. The indicator 142 can also be grabbed and moved to dynamically advance or rewind the playback of the multimedia. Scroll bars 144 and other objects can also be provided to control the playback of the multimedia.

As shown, the timeline 140 is configured to display graphical representations of annotations, such as events 130, 132, 134 and tags (not shown). The graphical representations of the tags and events are displayed in such a way as to reflect the relative position and duration of the multimedia content that the tags and events correspond to. In the present illustration, all of the events 130, 132, 134 are shown to correspond to separate content all having about the same duration. It will be appreciated, however, that the events can correspond to any duration of content and such that events may or may not overlap.

When events overlap, they can still be displayed on the timeline 140 as visually distinct elements, by applying varying degrees of transparency, by layering horizontally (while at least visually showing at least the start point of each event), by stacking vertically, as well as combinations of the above and other display schemes.

When there are many events that overlap, it is possible to filter the displayed view of events to only display certain events corresponding with particular content or commentary, with a particular event creator, by size, by reference to other content (such as when information is provided through the event that links to other resources), or by any other distinguishable event characteristic.

Inasmuch as many tags, created by different entities, can be assigned to each event, it is also possible to filter the timeline to display only selected sets of tags corresponding with particular content or commentary, with a particular tag creator, by size, by reference to other content, or by any other distinguishable event characteristic. Although the present illustration only shows graphical representations of events 130, 132 and 134, it will be appreciated that any combination of tags and events can be shown at the same time. For example, in some instances the assigned tags to an event are omitted from the display. In other instances, only tags are displayed.

A specific tag display frame 146 is also provided to textually represent the tags that correspond to the displayed multimedia content. In some instances, all of the tags 150 corresponding to an event that is either selected or that is associated with displayed content on the display frame 110 are listed in the tag display frame 146.

A comment display frame 160 is also provided to display comments corresponding to events and/or tags identified with the timeline 140 or tag display frame 146. The comments can be default comments associated with a tag and/or event, or custom comments added at any time.

When different authors create comments, tags and events, metadata associated with the comments is stored and associated with the multimedia file so that when the multimedia file is rendered, the appropriate and corresponding comments, tags and events are represented. In some instances, different coloring and display schemes are used to distinguish the comments authored by different entities and that are displayed within the display frame 160, by applying different colors, fonts, and/or typesetting to the comments made by the different authors. The graphical and textual representations of different tags and events displayed on the interface 100 can also be similarly distinguished by using the different coloring and display schemes described above.

A reviewing frame 220 is also provided by the interface 100 for displaying textual representations of the events 120, 122, 124, the tags 150, 152 and 154 and the comments corresponding to the multimedia content being displayed. For example, in the present embodiment, the events ‘the beginning,’ the middle,’ and ‘the end’ (120, 122, 124) are displayed along with all of their assigned tags 150, 152, 154. The reviewing frame 220 can also be used to edit, in-line, comments that have been associated with and displayed with an event or tag in the reviewing frame 220.

To sort the tags and events displayed in the reviewing frame 220, the user can select from a plurality of sorting/filtering options 170. In some instances, the sorting/filtering options sort the tags and events. In other embodiments, the sorting/filtering options filter the tags and events so that an incomplete set of the assigned events and/or tags are displayed. A textual word search field 180 can also be used to search for and filter tags and/or events that match the text entered into the search field 180.

The illustrated interface 100 also includes a tagging frame 210 which is hidden in FIG. 1, but which is displayed in FIG. 2. The tagging frame 210 provides menus 292 for selecting existing tags, creating new tags, transferring tags over a network to a third party system, for receiving tags over a network from a third party system, and for modifying tags and their attributes. Similar menus can also be provided for modifying and creating events.

It will be appreciated that the ability to transfer and share tags between multiple parties is particularly useful for facilitating and promoting collaboration and sharing of ideas and experience.

As shown in FIG. 2, an ‘interviewing techniques’ tag set has been identified and displayed. This tag set includes tags 230, 240, 250 and 260, each of which has a name (e.g., T-funnel (280), Time-Line, Narrative Statement, and Open Question). It will be appreciated, however, that the names of the tags do not limit the scope of the invention, as the tags can be assigned any names.

In some instances, the tags are associated with hotkeys or function buttons on a keyboard or input device. For example, in the present example, graphical representations of the tags, such as element 270, reflect corresponding buttons on a keyboard that can be pushed to select a tag and to assign a tag to a portion of multimedia content being displayed. Each of the tags is also shown to have corresponding text, such as the text identified by element 290. The language and format of the text is non-limiting, inasmuch as any text can be associated with a tag.

When a tag is selected and assigned to multimedia content or an event, the corresponding text of the tag is also assigned to the multimedia content. In some instances, tags can also refer to other data that is not displayed or immediately available without additional acts of navigating to or downloading the content. For example, a tag can reference a multimedia file or other data that is only accessible through a link and which may be available only through a network connection. Such embodiments can be particularly useful in the educational industry in which there are numerous related references to link to and so that the references can be selectively accessed while at the same time conserving storage on the client system and while minimizing the requirements that would otherwise be required to display all of the resource information.

The tags identified in the tagging frame 210, whether selected from the tagging frame 210, or whether they are automatically selected by a keystroke of a hot key, are typically assigned to the multimedia content that is being rendered when the tag is selected.

In some instances, the selection of a tag also initiates the creation of an event. FIG. 3, for example, illustrates a flowchart 300 of one embodiment in which multimedia content is annotated with events that are generated at least in part by the selection of a tag. Some of the embodiments reflected by FIG. 3 will now be described with respect to FIGS. 1 and 2.

The first step illustrated in FIG. 3 is a step for generating an event. In some instances an event is created in response to input provided in an event generating menu or in response to selecting a button, such as one of the control objects 114. In other instances, an event is generated in response to the performance of a combination of the corresponding acts reflected in FIG. 3. For example, a tag can be selected by clicking on a tag in the tagging frame 210 or by a key stroke (act 320), the tag is then assigned to the multimedia it corresponds to (act 330).

The assignment of the tag to the multimedia (act 320) can occur automatically by creating metadata associating the tag to the portion of the multimedia that is being rendered at the time the tag is selected. The assignment can also occur in response to a tag or tag representation (textual or graphical) being dragged and dropped onto the display frame 110 that the multimedia content is rendering. In other instances, the tag or tag representation is dragged and dropped onto the timeline to initiate the assignment of the tag to the multimedia content.

One beneficial advantage to dragging and dropping onto the timeline is that the tag can be effectively assigned to content other than the content that was being displayed on the display frame at the exact moment the tag was selected. Accordingly, if the user was too slow in selecting the tag, the user can still select and drag the tag representation to the timeline and drop the tag representation onto the timeline wherever they want, which effectively assigns the tag to the multimedia content that corresponds to the referenced drop spot/time within the timeline.

In some instances, the movement of a tag representation over the timeline can also be used to dynamically advance the presentation of the multimedia content, as it is dynamically displayed the display frame 110, to the relative position in which the tag representation is hovering over the timeline. This way, the user can selectably see and adjust, with some precision, which content the tag will be associated with.

After the tag is selected and assigned to the multimedia content (acts 320 and 330), a start time and end time for the event are set. In some instances, the start time corresponds exactly to the relative time within the multimedia presentation when the tag was attached or ‘dropped.’ In other instances, a user is provided with a menu for specifying a relative start time with respect to the multimedia presentation. A user can also be presented with menu options for adjusting the end times. In alternative embodiments, the end time is a default end time that falls a fixed duration after the start time and which is subsequently adjusted.

Any comments or annotations associated with the event, such as, for example, clarifying the subject matter of an event or the author of an event can be added when the event is created or at any later time. In some embodiments, the comments corresponding to an event are added directly to the comment display frame 160 when the event is created or subsequently displayed (act 370).

The display of the event (act 370) can occur through various combinations of textual and graphical representations, as described above with reference to the reviewing frame 220. Any event can also be displayed or represented within the timeline 140. A selection of the event from the timeline 140 can also initiate a more detailed view of the event along with text and commentary corresponding to the event. This is particularly beneficial when the displayed event icons in the timeline do not include any text.

Selection of an event can also commence the playback of the multimedia at the start point of the event. When multiple tags have been created for or assigned to a single event, the display of the event can include displaying all of the assigned tags with the event.

The event can also be edited (act 380), when desired, through the reviewing frame 220, by selecting a specific event to edit, or by selecting an event from the timeline 140 and editing the tags displayed in the tag display frame 146 and the comments displayed in the comment display frame 160.

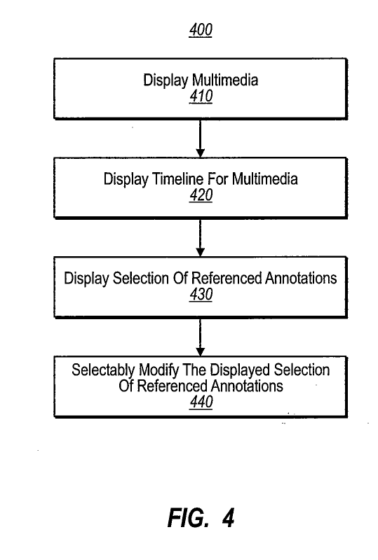

Attention will now be directed to FIG. 4, which illustrates a flowchart 400 of one embodiment for modifying the display of the timeline and corresponding tags and events. As mentioned above, a multimedia presentation can include a plurality of events, each of which can also include multiple tags. Because of this, it may become difficult to cleanly reflect all of the tags and events on the timeline, and such that it may become desirable to limit the number or type of events and tags that are represented on the timeline.

According to FIG. 4, a method is provided for displaying multimedia content with one or more referenced annotations, such as, for example, tags and events. The first recited act displaying multimedia content (act 410). It will be appreciated, however that the content must first be identified and accessed, either locally or remotely through an appropriate communication link.

The display of the multimedia content preferably, although not necessarily, occurs by displaying the multimedia content in the display frame 110 of the interface described above. In some instances, display of the multimedia content comprises displaying only a representation of the multimedia content, such as, for example, when the multimedia content is audio only.

The illustrated method also includes generating and displaying a timeline with the multimedia content that corresponds temporally to the display of the multimedia content. (act 420). In some embodiments, the timeline shows times and durations of the multimedia content with appropriate segment markers.

Graphical representations of the referenced annotations (e.g., tags and events) corresponding to the multimedia content are also displayed on the timeline (act 430). Although it is possible to reflect all of the tags and events, it is not necessary. In fact, in some embodiments, only tags are shown or only events are shown, omitting the other. In other embodiments only a filtered selection of tags and/or events is represented on the timeline.

The combination of one or more tags or events represented on the timeline can be automatically determined in response to graphical size constraints or by user selection.

Although the embodiments illustrated in FIGS. 1 and 2 show the graphical representations of the events include textual descriptions, it will be appreciated that the graphical representations of the tags and events on the timeline can include or omit text. Furthermore, even though no tags are presently reflected on the timeline, as the view is a filtered event view, any number of tags can be illustrated with or without the events.

According to one embodiment, the graphical representation of the referenced annotations (tags and events) are visually distinguishable based on coloring schemes that apply different colors to the different types of tags and events, based on their content, based on the entity that created the event or tag, based on the entity that assigned the event or tag, based on duration, quantity of comments, related data, or any other attribute or combination of the above.

At any time, the display of the timeline can also be modified, such as, for example, by displaying new and different combination of tags or events in response to user input selecting a filtered view. Various menu interfaces can be provided for receiving user input selecting a filtered view. In some embodiments, a filtered view is selected in part by input received with input elements 170 and 180. When a filtered view is selected, any combination of events and tags are omitted from view in the timeline.

The display of events and tags can be controlled through the use of menu options and settings, as described above. Events and tags can also be displayed automatically in response to a tag being dragged and dropped onto the display frame 110 or timeline 140, such as, for example, during the creation of a new event.

In summary, it will be appreciated that the present invention provides many advantages over existing multimedia and performance analysis applications in the industry. For example, the present invention provides means for filtering and displaying annotated references to multimedia in a timeline that visually distinguishes between the types of annotations and the attributes of the annotations, and without having to necessarily use textual descriptions within the timeline. The manner in which events and tags are associated with the content also provides great flexibility and user convenience and precision, particularly when using the drag and drop functionality. The visual display of comments, tags and events with the multimedia content is also very user-friendly and appealing.

Computing Environment

Although the subject matter of the invention has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Furthermore, although a specific computing architecture has not been illustrated in the drawings, it will be appreciated that the computing systems of the present invention can include one or more display screens and sufficient computing modules for generating the user interface displays on the one or more display screens and for implementing the methods described above.

The computing systems of the present invention can also include any quantity of different computing devices that communicate through any combination of hardwired and/or wireless network connections. For example, when tags are transmitted or shared, they can be transmitted or shared through a distributed network, such as the Internet. Sharing of data can also occur through physical computer-readable media.

Although many of the embodiments of the invention are suitable for implementation on stand-alone computing devices, it will be appreciated that any combination of the acts and steps described below for implementing methods of the invention can be executed at a client computing system and/or at a server computing system in communication with the client system and in response to commands received at the client system.

The foregoing embodiments of the present invention may comprise any special purpose or general-purpose computer including a processor for processing computer-executable instructions recorded on computer-readable media. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions, such as those described above with regard to the acts and steps of the recited methods. The computer-executable instructions also generate the user interface displays described above and facilitate the reading and assignment of tags, events and multimedia content.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What we claimed is:

1. A method for displaying multimedia content with one or more referenced annotations, comprising:
identifying multimedia content;
displaying the multimedia content on a display screen within a display frame of a user interface;
generating an event corresponding to a selected portion of the multimedia content, wherein generating the event includes:
selecting a tag associated with an annotation,
assigning the tag to the multimedia content by dropping a graphical representation of the selected tag on a least one of the display frame or a timeline corresponding to the multimedia;
assigning a start time of the event,
assigning an end time of the event, and
assigning comments to the event; and
displaying a graphical representation of the event with the multimedia content.

2. A method as recited in claim 1, wherein the method further includes displaying the timeline with the multimedia and wherein generating the event includes dropping the graphical representation of the selected tag onto the timeline.

3. A method as recited in claim 2, wherein the start time assigned to the event is automatically assigned in response to the dropping of the graphical representation of the selected tag onto the timeline at a position within the timeline that corresponds with the start time.

4. A method as recited in claim 1, further comprising:
displaying a graphical representation of the event on the timeline.

5. A method as recited in claim 4, wherein the graphical representation of the event includes a color that distinguishes the event from at least one other graphical representation of a different event that is also displayed on the timeline.

6. A method as recited in claim 1, further comprising:
assigning a plurality of tags to the event, and
displaying graphical representations of each of the plurality of tags on the display screen, wherein at least a first and second tag are assigned to the event by first and second entities, respectively, and wherein the graphical representation of the first tag is visually distinguishable by at least color from the graphical representation of the second tag.

7. A method as recited in claim 1, further comprising:
assigning a plurality of tags to the event, and
in response to a user selection of the event, displaying each of the plurality of tags assigned to the event.

8. A method as recited in claim 7, wherein the method further includes displaying graphical representations of each of a plurality of different events on the timeline while at the same time displaying each of one or more tags assigned to a selected one of the different events with the comments assigned to the selected one of the different events.

9. A method as recited in claim 1, wherein the method further comprises:
displaying a graphical representation of at least one corresponding event or tag on the timeline in a first instance; and
subsequently, in response to user input, selecting a filtered view of the timeline, omitting to display said graphical representation and without deleting or otherwise absolving an existing assignment of said event or tag to the multimedia.

10. A computer program product comprising one or more computer-readable media having computer-executable instructions for implementing the method recited in claim 1.

11. A method for displaying multimedia content with one or more referenced annotations, comprising:
identifying multimedia content;
displaying the multimedia content on a display screen within a display frame of a user interface;
generating and displaying a timeline with the multimedia content that corresponds temporally to the display of the multimedia content;
displaying a graphical representation of referenced annotations on the timeline, wherein the referenced annotations include a combination of at least one or more tag or event assigned to the multimedia, and wherein the graphical representation of the referenced annotations visually distinguishes tags and events of different types through the application of a coloring scheme that applies different colors to the different types of tags and events.

12. A method as recited in claim 11, wherein the coloring scheme is based at least in part on content and categorization of annotations assigned to the multimedia by the tags and events.

13. A method as recited in claim 11, wherein a coloring scheme is based at least in part on a determination of who assigned the tags and events to the multimedia.

14. A method as recited in claim 11, further comprising:
modifying the display of the graphical representation of the referenced annotations in response to a filtering request which causes a new and different combination of at least one or more tag or event assigned to the multimedia to be displayed on the timeline.

15. A method as recited in claim 11, wherein the combination of at least one or more tag or event displayed on the timeline includes at least one event and omits at least one tag corresponding to the at least one event.

16. A method as recited in claim 11, wherein the combination of at least one or more tag or event displayed on the timeline includes at least one tag and omits at least one known event assigned to the multimedia.

17. A method as recited in claim 1 1, wherein the method includes automatically displaying a graphical representation of at least one event on the timeline in response to dragging and dropping a graphical representation of a tag onto the display frame of the multimedia.

18. A method as recited in claim 11, wherein the method includes automatically displaying a graphical representation of at least one event on the timeline in response to dragging and dropping a graphical representation of a tag onto the timeline.

19. A computer program product comprising one or more computer readable media having computer-executable instructions for implementing the method recited in claim 11.

20. An interface displayed on a display screen in response to computer-executable instructions being executed by a computing device, comprising:
a display frame for displaying multimedia content accessible to the interface;
a timeline that corresponds temporally to the display of the multimedia content;
a comment frame for displaying comments corresponding to at least one of an event and tag assigned to multimedia content as the multimedia content is displayed and simultaneously with the display of the timeline and multimedia content;
a tagging frame that provides selections of tags corresponding to annotations and that further provides options for creating and transferring tags, wherein the tagging frame further includes the display of at least one tag that is selectable and that can be automatically assigned to the multimedia content in response to a selection of the tag; and
a reviewing frame that is separated from the comment frame and that displays filtered and sorted lists of tags and events corresponding to the multimedia content along with commentary corresponding to at least one of the tags and events.
